(19) United States
(12) Patent Application Publication
(10) Pub. No.: US 2024/0334459 A1
(43) Pub. Date: Oct. 3, 2024

(54) DEPLOYMENT OF BASEBAND UNITS

(71) Applicant: International Business Machines Corporation, Armonk, NY (US)

(72) Inventors: Maja Curic, Munich (DE); Sagar Tayal, Ambala City (IN)

(21) Appl. No.: 18/307,904

(22) Filed: Apr. 27, 2023

(30) Foreign Application Priority Data
Mar. 29, 2023 (GB) 2304567.7

(51) Int. Cl. H04W 72/50

(52) U.S. Cl. CPC H04W 72/50

(57) ABSTRACT

The present disclosure relates to a method for processing baseband signals for serving a group of users in a wireless communication system. The method comprises: selecting a specific baseband unit of a set of baseband units which is different from a current baseband unit that serves a group of users. Users of the group of users that fulfil a migration criterion for migration to the selected baseband unit may be identified. The identified users may be ranked according to services accorded by the wireless communication system to the identified users. The selected baseband unit may be controlled to serve, instead of the current baseband unit, the identified users following their order.

### BACKGROUND

The present invention relates to the field of digital computer systems, and more specifically, to a method for processing baseband signals.

A radio access network (RAN) may provide access to and coordinate the management of resources across sites of a mobile telecommunication system in accordance with a protocol stack. Different implementations of the radio access network may be used. Each implementation may be realized by a specific hardware and software configuration. For example, an implementation may consist of disaggregating the protocol stack so that individual components of the protocol stack can be realized independently. This may enable better system performance. However, the deployment of these components may not be tailored to different network conditions.

### SUMMARY

Various embodiments provide a method for processing baseband signals, computer program product and system as described by the subject matter of the independent claims. Advantageous embodiments are described in the dependent claims. Embodiments of the present invention can be freely combined with each other if they are not mutually exclusive.

In one aspect, the invention relates to a method for processing baseband signals for serving a group of users in a wireless communication system. The method comprises: providing a set of baseband units each being implemented in a respective hardware and software configuration, wherein the group of users are being served by a current baseband unit of the set of baseband units; selecting a specific baseband unit of the set of baseband units which is different from the current baseband unit; identifying users of the group of users that fulfil a migration criterion for migration to the selected baseband unit; ranking the identified users according to services accorded by the wireless communication system to the identified users; and controlling the selected baseband unit to serve, instead of the current baseband unit, the identified users following their order.

In one aspect the invention relates to a computer program product comprising a computer-readable storage medium having computer-readable program code embodied therewith, the computer-readable program code configured to implement the method of the above embodiment.

In one aspect the invention relates to a computer system for a wireless communication system. The wireless communication system comprises a set of baseband units each being implemented in a respective hardware and software configuration, wherein a group of users are being served by a current baseband unit of the set of baseband units. The computer system is configured for: selecting a specific baseband unit of the set of baseband units which is different from the current baseband unit; identifying users of the group of users that fulfil a migration criterion for migration to the selected baseband unit; ranking the identified users according to services accorded by the wireless communication system to the identified users; and controlling the selected baseband unit to serve, instead of the current baseband unit, the identified users following their order.

### BRIEF DESCRIPTION OF THE DRAWINGS

In the following embodiments of the invention are explained in greater detail, by way of example only, making reference to the drawings in which:

FIG. 1A is a block diagram of a wireless communication system in accordance with an example of the present subject matter.

FIG. 1B depicts an example implementation of the baseband units.

FIG. 2 is a flowchart of a method for processing baseband signals in accordance with an example of the present subject matter.

FIG. 3 is a flowchart of a method for ranking users in a wireless communication system in accordance with an example of the present subject matter.

FIG. 4 is a flowchart of a method for ranking users in a wireless communication system in accordance with an example of the present subject matter.

FIG. 5A is a flowchart of a method for ranking users to be migrated in accordance with an example of the present subject matter.

FIG. 5B is a table listing identified subgroups of users in accordance with an example of the present subject matter.

FIG. 5C is a table listing identified subgroups of users in accordance with an example of the present subject matter.

FIG. 6 is a flowchart of a method for deploying baseband units in accordance with an example of the present subject matter.

FIG. 7A is a diagram illustrating a method for migrating users from one stack to another stack in accordance with an example of the present subject matter.

FIG. 7B is a diagram illustrating a method for migrating users from one stack to another stack in accordance with an example of the present subject matter.

FIG. 7C is a diagram illustrating a method for migrating users from one stack to another stack in accordance with an example of the present subject matter.

FIG. 8 is a signalling diagram of migration process between two deployed stacks in accordance with an example of the present subject matter.

FIG. 9 is a computing environment in accordance with an example of the present subject matter.

FIG. 10 depicts a cloud computing environment according to an embodiment of the present invention.

FIG. 11 depicts abstraction model layers according to an embodiment of the present invention.

### DETAILED DESCRIPTION

The descriptions of the various embodiments of the present invention will be presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A wireless or mobile communication system may be provided. The mobile communication system provides wireless connectivity to users. The users may, for example, comprise mobile devices, tablets, laptops or individuals. The mobile communication system may comprise a radio access network (RAN) and a core network. The core network may provide Internet Protocol (IP) connectivity to the radio access network. The radio access network may manage the radio spectrum of users using radio devices such as base stations. The radio access network may enable to process packets in accordance with a processing pipeline. The processing pipeline has different layers. The layers include baseband processing layers and radio frequency (RF) processing layers. The baseband processing layers may be defined in accordance with a protocol stack and may be performed by a baseband unit.

The baseband unit may be associated with one or more base stations. For example, each base station of the one or more base stations may serve users located within the base station's geographical area of service or a cell. The baseband unit may process baseband signals for served users of the one or more base stations. Thus, the baseband unit is said to be serving said users. The baseband unit may implement the layers of the protocol stack such as the Packet Data Convergence Protocol (PDCP) layer, Radio Link Control (RLC) layer, Medium Access Control (MAC) layer and Physical (PHY) layer. In one example, the baseband unit may be divided into function entities each being configured to perform a respective function e.g., a function may implement one or more layers of the stack protocol. For example, the baseband unit may be divided into two function entities named Centralized Unit (CU) and Distributed Unit (DU). The CU may provide support for the higher layers of the protocol stack such as the PDCP layer while the DU provides support for the lower layers of the protocol stack such as the RLC, MAC and Physical layers. A baseband unit may be active or deployed, meaning that it is processing baseband signals for serving users.

The implementation of the baseband unit may be realized with a specific hardware and software configuration. The software and hardware configuration that implements the baseband unit may be referred to as “stack”. The software configuration of the baseband unit may comprise an operating system and software modules for performing the functions of the baseband unit. In addition, the software configuration may indicate one or more vendors that provide the software configuration. For example, the operating system and software modules may be provided by one or more vendors. The hardware configuration may comprise storage resources, data communication resources and processing resources. In addition, the hardware configuration may indicate one or more vendors that provide the hardware configuration. The resources may be provided by one or more vendors. Each combination of hardware and software configuration may be provided for a specific purpose. For example, a hardware and software configuration may be suitable for serving a high number of users, another hardware and software configuration may be suitable for minimal energy consumption and another hardware and software configuration may be suitable for minimum latency.

Hence, several vendors might be involved in the implementation of the baseband processing layers e.g., a single stack may be supplied by different vendors. For example, the hardware implementation of the baseband processing layers may be supplied by different vendors. Additionally, or alternatively, the software implementation of the baseband processing layers may be supplied by different vendors. This may enable to select the hardware and software configuration depending on a desired purpose. The purpose may, for example, be to serve a maximum number of users, or enable a minimum delay for Ultra-Reliable Low Latency (URLL) services or enable minimal energy consumption. For example, an operator may select and deploy the best of breed stack for a static deployment for the baseband unit that may be suitable for specific conditions of the mobile telecommunication system. However, the best of breed stack may not be ultimate feature of a product because the conditions of the mobile telecommunication system may change. In addition, a product from one vendor does not necessarily outperform products of all other vendors in each condition. The present subject matter may solve this issue by providing an efficient mechanism that enables dynamic stack updates with minimized interruptions for the users.

For that, the present subject matter may provide a set of baseband units. The set of baseband units may comprise a subset of one or more active or deployed baseband units. The remaining subset of baseband units may comprise predefined inactive baseband units and/or function entities of the baseband units (e.g., CUs and DUs). The function entities may advantageously be used to dynamically create/build the baseband units.

For example, a current baseband unit of the set of baseband units is being used for processing baseband signals of a group of users. That is, the current baseband unit serves the group of users. The present subject matter may enable to update the current baseband unit. For that, a specific baseband unit of the set of baseband units may be selected. The selected baseband unit may, for example, be a predefined inactive baseband unit. Alternatively, selecting the baseband unit may comprise dynamical creating the baseband unit from the provided function entities. The selection of the baseband unit may further comprise selecting or determining the hardware configuration (e.g., using virtualization) to implement the selected baseband unit. After selecting the baseband unit, users (of the group of users) that fulfil a migration criterion may be identified. These identified users may be incrementally or progressively migrated to the selected baseband unit. For that, the identified users may be ranked according to services accorded by the wireless communication system to the identified users. The selected baseband unit may be controlled to serve, instead of the current baseband unit, the identified users following their order. The selected baseband unit may serve the users by processing baseband signals that enable communication of data with the users.

Thus, the present subject matter may enable an efficient and dynamic deployment of the baseband units with minimal service impact to users.

According to one example, the selection of the specific baseband unit is performed in response to receiving a request to migrate the group of users from the current baseband unit. Alternatively, the selection of the specific baseband unit is performed in response to detecting that the current baseband unit does not fulfil a performance requirement for serving the group of users. The baseband unit is selected such that it fulfills that performance requirement. This example may enable a dynamic adaptation of the user servicing in the communication system. In particular, the group of users are progressively migrated to and thus served by the selected baseband unit instead of the current baseband unit in response to receiving the request or in response to detecting that the current baseband unit does not fulfil the performance requirement for serving the group of users.

The performance requirement may require specific values of and/or behavior of network parameters and/or user parameters. Specific values of the network parameters and user parameters may represent a network condition of the radio access network. The network parameters and user parameters may be evaluated by collecting data from the mobile communication system and/or predicting their values. In addition, a network operational policy may be provided e.g., the policy may be obtained from an operator of the mobile telecommunication system. The performance requirement may for example require that the evaluated network parameters and user parameters fulfill the operational policy. The operational policy may, for example, indicate in which network condition to prioritize low energy consumption or to prioritize maximum amounts of users. For example, a specific set of values of the network and user parameters may indicate that the low energy consumption is required e.g., the current baseband unit is not suitable for the low energy consumption. In this case, the selected new baseband unit is suitable for low energy consumption.

The network parameters may indicate the network behavior. The network parameters may, for example, comprise the number of deployed baseband units, the amount of available infrastructure resources and the deployed applications. The user parameters may, for example, comprise user experience and service utilization. The behavior or dynamics of the network parameters and user parameters may be identified using the collected information. In addition, the future trend of the user parameters may be predicted. For example, the user parameters may be evaluated for the users being served by the current baseband unit. The network parameters may be evaluated in relation to the current baseband unit e.g., the number of deployed baseband units may be the number of baseband unit deployed in the data center in which the current baseband unit is deployed, the amount of available infrastructure resources for the current database unit etc. Based on the collected values and predictions, it may be determined whether the current baseband unit fulfills the operational policy. In addition, the collected values and predictions may be used to select an optimal baseband unit that can fulfill the operational policy.

In one example, detecting that the current baseband unit does not fulfil the performance requirement comprises: regularly evaluating the network parameters and user parameters for the current baseband unit, and checking whether the current values of the network parameters and user parameters fulfill the operational policy; and in case it is not fulfilled determining that the current baseband unit does not fulfil the performance requirement.

According to another example, the performance requirement is one of: a maximum number of served users, a minimum transmission latency between a user and a base station; or a minimum energy consumption by the communication system. The performance requirement may refer to specific values of a metric, wherein the metric is the number of served users, the energy consumption, or the transmission latency. For example, detecting that the current baseband unit does not fulfil the performance requirement comprises regularly evaluating the metric for the current baseband unit, and checking whether the value of the metric fulfills the performance requirement; and in case the metric does not fulfil the performance requirement determining that the current baseband unit does not fulfil the performance requirement. Alternatively, detecting that the current baseband unit does not fulfil the performance requirement comprises receiving a request for specific performance requirement for serving the users and checking whether the current baseband unit fulfils the requested performance requirement.

The identified users may be ranked in order to progressively migrate them to the selected baseband unit. The ranking of the identified users is performed according to services accorded by the wireless communication system to the identified users. In one example, the service accorded to the user may comprise a maximum transmission latency between the user and the base station; a user class of the user; a maximum packet loss for packet transmission to or from the user or a minimum coverage quality by the base station serving the user. For example, these services are accorded based on a Service Level Agreement (SLA) signed between the user and a service provider associated with the wireless communication system. The SLA may, for example, list or specify the services accorded to the user. This example may enable the migration of the group of users while still fulfilling the services accorded to the users. This may enable a seamless integration of the present method in existing systems.

When a migration is carried out from the current baseband unit to the selected baseband unit, a finite amount of time exists during which the user can neither transmit nor receive the data. This time is referred to as interruption time. The present subject matter may advantageously use the interruption time for ranking the group of users. In one example, the identified users may be grouped into two subgroups. The first subgroup comprises users whose accorded service is not impacted by the interruption time. The second subgroup comprises users whose accorded service is impacted by the interruption time. For example, the service accorded to the users is a maximum transmission latency. In this case, if the maximum transmission latency accorded to a user is shorter than the interruption time, then that user may be impacted; otherwise, the user may not be impacted. The first subgroup users may thus be ranked before or higher than the second subgroup users. The migration to the selected baseband unit may first be performed for the first subgroup of users and subsequently followed by the migration of the second subgroup of users. The users within the same subgroup may have the same ranking order. In this case, the migration of the users within the same subgroup may be performed in any order or in parallel.

The present subject matter may further improve the ranking by further ranking the users within the second subgroup (of impacted users). For that, users of the second subgroup whose perceived service is not impacted by the interruption time may be selected. For example, the user may be accorded a service; however, the user may perceive or use only part of the service for several reasons e.g., an old mobile phone may be accorded a very short transmission latency as a service but due to its old configuration it may only achieve a longer transmission latency that is longer than the interruption time. Thus, even accorded a very short transmission latency, the mobile phone may not be affected by the interruption time. Thus, the first subgroup and the second subgroup may be updated according to this additional ranking. For example, before the migration is performed those selected users may be included in the first subgroup and removed from the second subgroup. This example may further improve the migration process.

According to one example, the method further comprises predicting user experience of the second subgroup of users, determining a level of impact of the accorded service using the user experience, and ranking the second subgroup of users according to the level of impact. The user experience may comprise at least one of: a mobility pattern of the user, a service activity pattern of the user or connection status pattern of the user. For example, each user of the second subgroup may be assigned a score indicating the level of impact of the interruption time. This score may be evaluated using the predicted user experience. For example, a user may have a connection status pattern indicating that the user is regularly in the Idle state e.g., the user stays only for short time in the connected state. In this case, this user may not be impacted by an upcoming migration and thus may be assigned a lowest score indicating a low level of impact of the interruption time. In another example, if the service activity pattern of a user indicates that the user often requires very low latency, this user may be impacted by an upcoming migration and thus may be assigned a highest score indicating a high level of impact of the interruption time.

According to one example, after migrating the first subgroup of users, the migration of the second subgroup of users may be delayed for a defined delay period. This may be advantageous as the behaviour of the second subgroup of users may change over time. For example, users may have a future pattern that may not be impacted by the interruption time e.g., the users are predicted to become Idle users in a future time period.

According to one example, the migration criterion requires a maximum mobility of the user, wherein the mobility includes a speed or acceleration of the user, wherein the non-identified users of the group of users are high mobility users having the mobility above a threshold. The high-mobility users are most likely to move to another area where they can be served by another baseband unit and thus there is no need to migrate them to the selected baseband unit. This may save processing resources that would otherwise be required for, unnecessarily, migrating these high-mobility users to the selected baseband unit.

According to one example, the control of the selected baseband unit is performed by a central media access control (MAC) layer of the wireless communication system. The central MAC layer may incrementally distribute the physical radio resources across the current baseband unit and the selected baseband unit. This may enable a centralized control at one point of the communication system.

According to one example, the control of the selected baseband unit comprises reassigning time and frequency resources between the current baseband unit and the selected baseband unit.

According to one example, the ranking is performed using user profiles of the group of users. The user profile may, for example, be a near-real time user profile.

According to one example, the computer-readable program code is provided as a service in a cloud environment. For example, the set of baseband units may be implemented in a node of a private cloud.

In one example, the selection of the baseband unit for updating the current baseband unit may be performed using a simulation analysis. The simulation analysis may use a set of digital twins. The set of digital twins may comprise digital twins of the users and digital twin of the radio access network. The simulation analysis may produce simulation data indicating for example the user experience and network conditions.

The simulation data may be used to identify the optimal stack combination for a given network condition and user behaviour. The optimal stack combination refers to the optimal hardware and software configuration that implements a baseband unit. The simulation data may be used to identify the possibility for stack update given the current and predicted network conditions and user behaviour, including identifying practical possibility for stack parallelism in the context of available resources to perform the update e.g., possibility for intra-data centre stack swap and remote data centre assisted stack swap and in the context of impact on the current and predicted expected customer experience. The simulation data may be used to automatically generate a workflow for stack swap inducing recommendations for the migration procedure flow during the swap including users to be migrated, timings of each migration, user to stack mapping, etc. The simulation data may be used to optimize traffic distribution across the stacks that run in parallel.

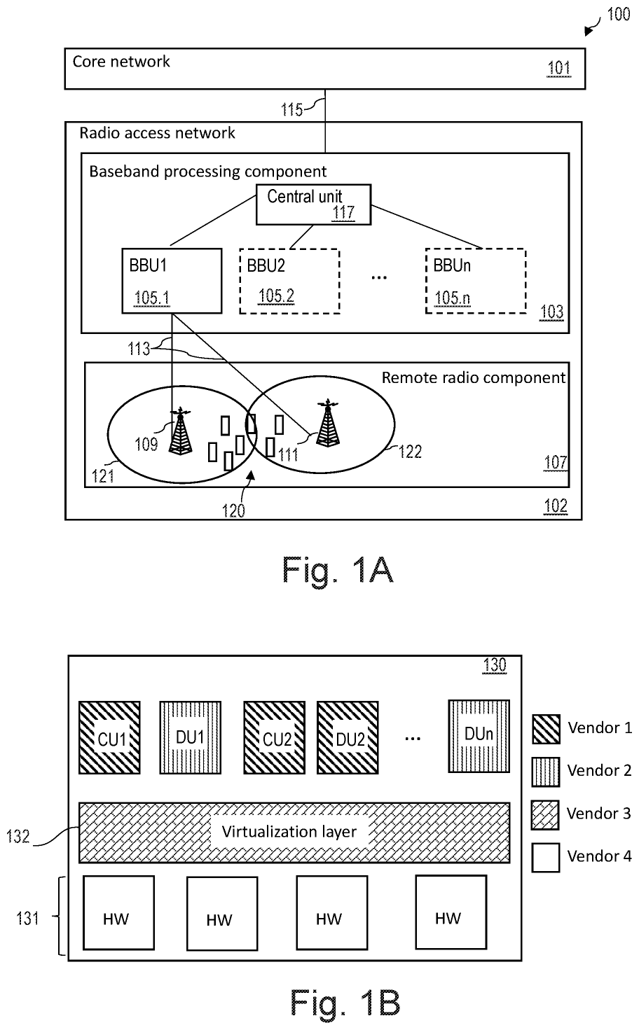

FIG. 1A depicts a diagram of a wireless communication system in accordance with an example of the present subject matter. The wireless communication system 100 comprises a core network 101 and a radio access network 102. The radio access network 102 may comprise a remote radio component 107 equipped by, but not limited to, base stations 109 and 111. Each base station 109 or 111 may comprise a remote radio unit (RRU) with antennas. The radio access network 102 may further comprise a baseband processing component 103 including a set of baseband units (BBUs) 105.1-n. The baseband unit may be connected to a respective RRU in the remote radio component 107 through a fiber or cable 113. The baseband processing component 103 may be configured to connect to the core network 101 via a backhaul link 115. The baseband processing component 103 may comprise a central unit 117 which is configured to control the operation and deployment of the baseband units 105.1-n.

In the present example, the baseband unit 105.1 is active, meaning that it provides baseband samples to the base station 109. Optionally, the baseband unit 105.1 may further provide baseband samples to the other base station 111. This may enable to share the same baseband unit between two or more base stations. The remaining baseband units 105.2 are not active or not being used. They may be provided as spares that can be efficiently used according to the present subject matter. The baseband unit 105.1 may be referred to as the current the baseband unit 105.1. The current baseband unit 105.1 may process baseband signals for a group of users 120 being served by the base stations 109 and 111 within the respective coverage areas 121 and 122.

In one example implementation, the system 100 may be provided as an Open Radio Access Network (O-RAN), where the baseband processing component 103 may comprise one or more edge sites and the remote radio component 107 may comprise one or more cell sites.

FIG. 1B depicts an example implementation of the baseband units 105.1-n. The baseband units 105.1-n may, for example, be implemented in a data centre 130. However, it is not limited to, as the baseband units 105.1-n may be implemented in more than one data centre. FIG. 1B provides the software and hardware configuration for each baseband unit in accordance with virtualization. This may enable an efficient usage of hardware resources of the data centre 130.

The data centre 130 comprises a hardware layer 131 and a virtualization layer 132. The virtualization layer 132 is deployed across various hardware resources of the hardware layer 131 that are available in the data centre 130, but not necessarily all of them. The hardware layer may be provided by vendor 4. The virtualization layer may be provided by vendor 3. The hardware layer 131 may comprise storage and computing resources such as CPU and GPU which can be organized in nodes. The underlying resources are virtualized by middle of the virtualization layer 132.

The virtualization layer 132 may integrate heterogeneous storage and computing power to generate a virtual machine to handle the processing of a baseband unit. For example, each baseband unit may comprise a central unit and distributed unit, e.g., BBU1 has CU1 and DU1, . . . , BBUn has CUn and DUn. This may enable a flexible deployment of the baseband units in the data centre 130. The central units and distributed units may be provided by different vendors vendor 1 and vendor 2.

The present system may thus enable disaggregation. The disaggregation may result with richer ecosystem of network function providers. The operators can select the best of breed implementations of the network functions such as CU and DU functions. However, one specific network function implementation may not perform the best in each and every network condition. The same applies for the entire network stack, which is composed of the components from different vendors. A specific combination of network components can outperform the others only during specific network conditions. The present subject matter may solve this issue by dynamically adapting the currently deployed baseband units.

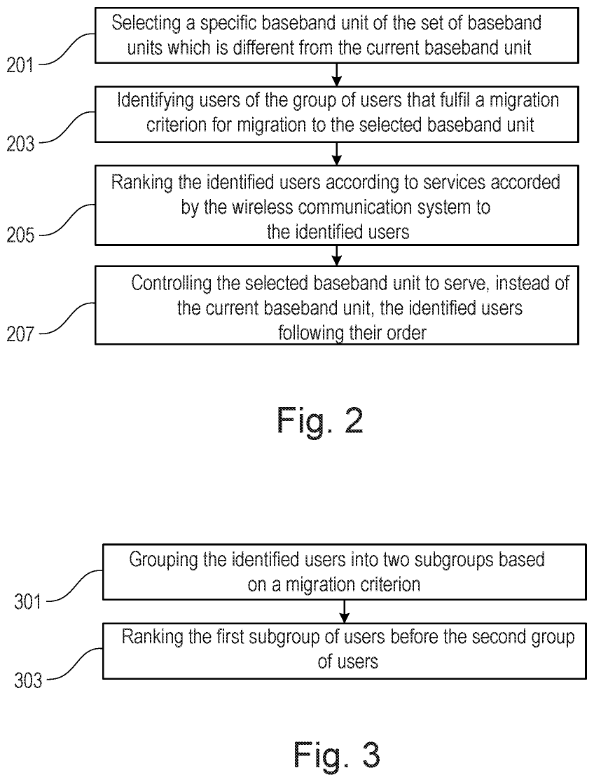

FIG. 2 is a flowchart of a method for processing baseband signals for serving a group of users in a wireless communication system in accordance with an example of the present subject matter. For the purpose of explanation, the method of FIG. 2 may be implemented in the system of FIG. 1A, but it is not limited to. The method may, for example, be performed by the central unit 117.

A specific baseband unit of the set of baseband units 105.1-n which is different from the current baseband unit 105.1 may be selected in step 201. Users of the group of users 120 that fulfil a migration criterion for migration to the selected baseband unit may be identified in step 203. The identified users may be ranked in step 205 according to services accorded by the wireless communication system to the identified users. The selected baseband unit may be controlled in step 207 to serve, instead of the current baseband unit 105.1, the identified users following their order.

The specific baseband unit may be selected for several reasons. For example, the selection step 201 may be performed upon receiving a request to update the current baseband unit. Alternatively, the selection step 201 may be performed automatically on a periodic basis e.g., every day. Alternatively, the selection step 201 is performed in response to detecting that the current baseband unit does not fulfil a performance requirement. The detection comprises identifying conditions in which the currently deployed baseband unit is not optimal anymore (reactive) or will not be optimal in the near future (proactive).

FIG. 3 is a flowchart of a method for ranking users in a wireless communication system in accordance with an example of the present subject matter. For the purpose of explanation, the method of FIG. 3 may be implemented in the system of FIG. 1A, but it is not limited to. The method may, for example, be performed by the central unit 117. The method may provide an example implementation of step 205 of FIG. 2.

The identified users may be grouped in step 301 into two subgroups such that the first subgroup comprises users whose accorded service is not impacted by an interruption time during a migration to the selected baseband unit, and a second subgroup comprises users whose accorded service is impacted by the interruption time. The first subgroup users may be ranked in step 303 before the second subgroup users.

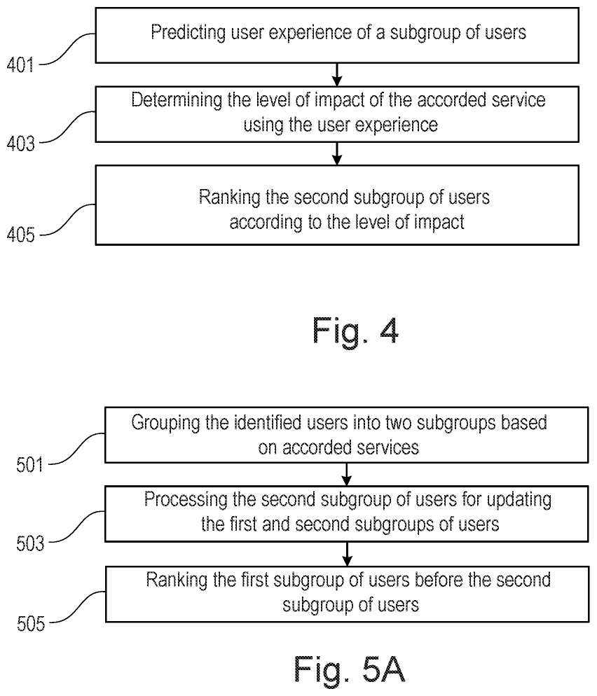

FIG. 4 is a flowchart of a method for ranking users in a wireless communication system in accordance with an example of the present subject matter. For the purpose of explanation, the method of FIG. 4 may be implemented in the system of FIG. 1A, but it is not limited to. The method may, for example, be performed by the central unit 117. The method may provide an example implementation of step 205 of FIG. 2.

User experience of the second subgroup of users may be predicted in step 401. A level of impact of the accorded service may be determined in step 403 using the user experience. The second subgroup of users may be ranked in step 405 according to the level of impact.

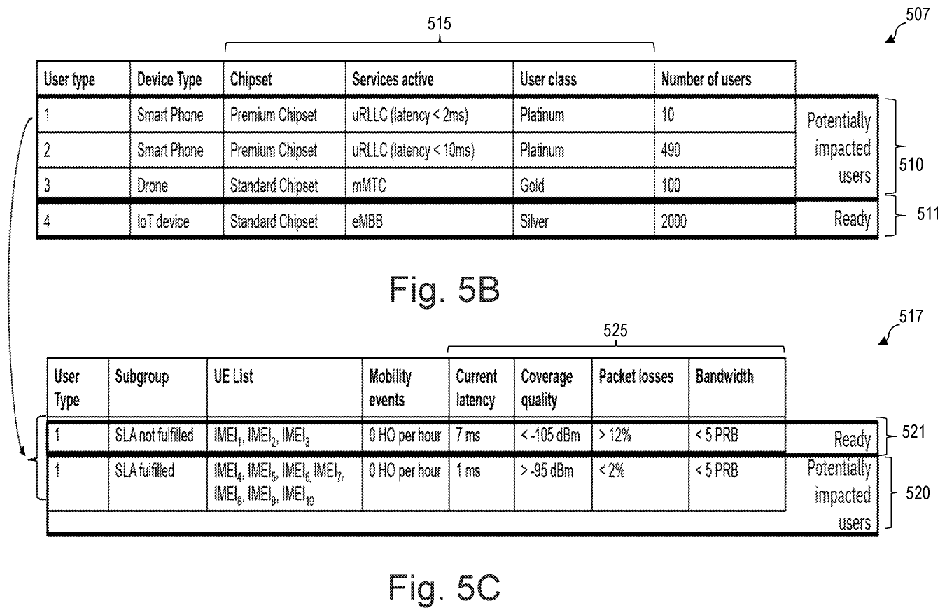

FIG. 5A is a flowchart of a method for ranking users to be migrated in accordance with an example of the present subject matter. For the purpose of explanation, the method of FIG. 5A may be implemented in the system of FIG. 1A, but it is not limited to. The method may, for example, be performed by the central unit 117. The method may provide an example implementation of steps 203-205 of FIG. 2.

In step 501, the users are grouped into two subgroups of users. These two subgroups of users are shown in table 507 of FIG. 5B. The grouping of the users may be performed using the services 515 accorded to the users. As shown in FIG. 5B, the services 515 may include the type of the chipset provided to the users. The chipset type may include a premium chipset and standard chipset. The services 515 may include the types of service such as uRLLC service, massive Machine Type Communications (mMTC) service and enhanced Mobile Broadband (eMBB) service. The services 515 may include a user class of the user. The user class may include a platinum class, gold class or silver class. The grouping may, for example, be performed such that the first subgroup of users 511 comprises users having lowest user class such as silver class and a service type other than uRLLC and remaining users may be part of the second subgroup of users 510. The second subgroup of users 510 may comprise users of different types. The user type may be defined by a device type such as a smartphone or drone or defined by on one or more of the services 515 accorded to the user. The first subgroup 511 may comprise users which are ready for migration to the selected baseband unit. The second subgroup of users 511 may comprise users which may be potentially impacted users, e.g., they may be impacted by the interruption time caused by the migration to the selected baseband unit. The table 507 further shows the number of users per subgroup and per user type.

The second subgroup 510 may further be processed in step 503 e.g., using perceived services, to determine whether users are in fact not impacted and thus ready for migration. For that, the services perceived by the users of the second subgroup may be used. This is illustrated with the table 517 of FIG. 5C. In particular, the table 517 show the perceived services 525 by users of the second subgroup 510, namely the 10 users of the first user type. As shown in table 517, the 10 users may be assigned International Mobile Equipment Identities IMEI₁ through IMEI₁₀ respectively. Each of the 10 users may have a mobility indicated by the number of handover (HO) per hour. The 10 users are accorded the uRLLC service with a latency below 2 ms; however, as indicated in table 517 the users 521 IMEI₁, IMEI₂ and IMEI₃ perceive a higher latency of 7 ms. In other words, the SLA associated with latency is not fulfilled for these three users 521. Similarly, the SLA associated with coverage quality, packet loss is not fulfilled for these three users 521. However, the SLA associated with services 525 is fulfilled by the remaining users 520 IMEI₄ through IMEI₁₀.

Hence, the three users 521 may be classified as ready for migration. The first subgroup 511 and the second subgroup 510 may be updated by adding the three users 521 to the first subgroup 511 and removing them from the second subgroup 510.

The updated first subgroup of users 511 may be ranked in step 505 higher than the updated second subgroup of users 510.

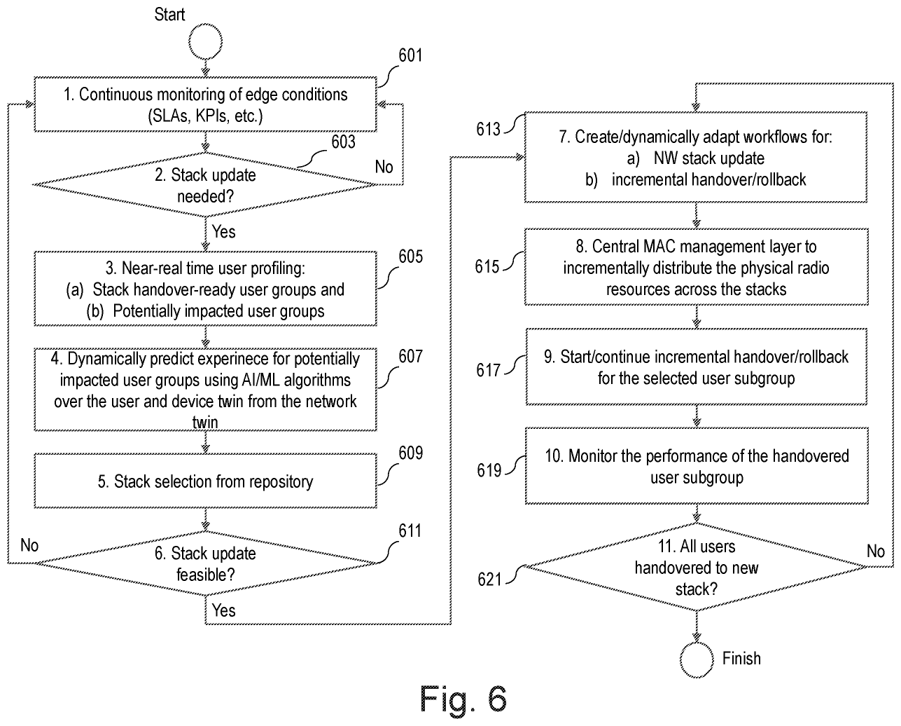

FIG. 6 is a flowchart of a method for deploying baseband units in accordance with an example of the present subject matter.

A continuous monitoring of edge conditions may be performed in step 601 e.g., using signed SLAs and monitored KPIs. It may be determined in step 603 whether a stack update is required. In case the stack update is not required, the method may be repeated by going back to step 601. In case the stack update is required, a near-real time user profiling may be performed in step 605. This may result in identifying stack migration-ready user groups and potentially impacted user groups.

Experience for potentially impacted user groups may be dynamically predicted in step 607 using artificial intelligence/machine learning (AI/ML) algorithms over the user and device twin from the network twin. A stack may be selected in step 609 from a repository of stacks. It may be determined in step 611 whether the stack update is feasible. In case the stack update is not feasible, the method may be repeated by going back to step 601.

In case the stack update is feasible, workflows may be created/dynamically adapted in step 613 for stack update and incremental migration/rollback of the identified users. The central MAC management layer may incrementally distribute the physical radio resources across the stacks in step 615. Incremental migration/rollback for the selected user subgroup may be performed in step 617. The performance of the migrated user subgroup may be monitored in step 619. It may be determined in step 621 whether all users have been migrated to the new stack. In case all users have been migrated to the new stack the method ends. In case all users have not been migrated to the new stack, the method goes back to step 613.

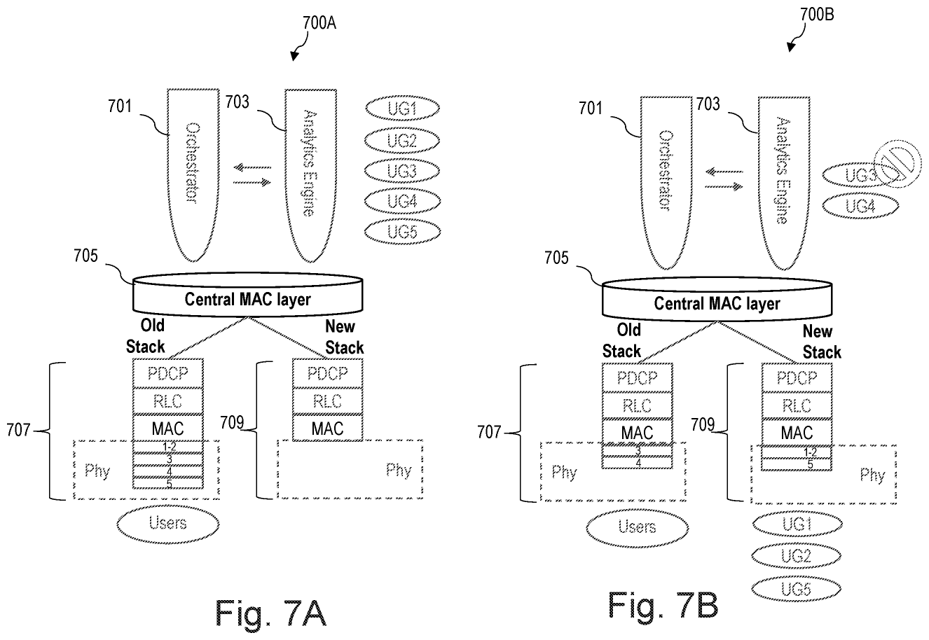

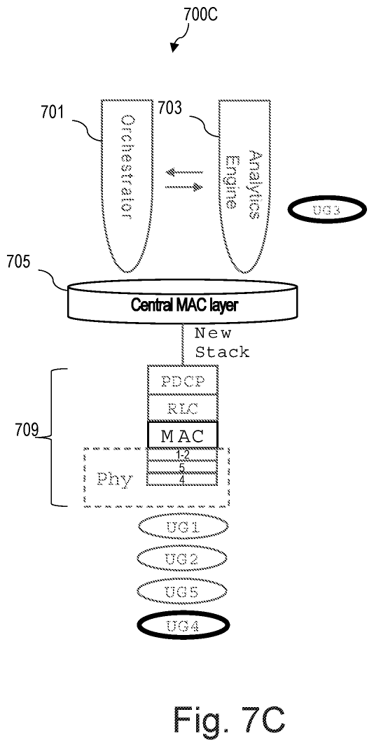

FIGS. 7A-C are diagrams illustrating stages 700A-C for migration of users from an old a stack to a new stack by a system. The system may comprise an orchestrator 701, an analytics engine 703 and a central MAC layer 705. The orchestrator 701 may collect data regarding users served by a base station whose baseband unit implements the old stack 707. The analytics engine 703 may use the user data such as user profiles to determine that the users may need to be served by a new stack 709. The central MAC layer 705 may manage the migration of the users to the new stack 709. The new stack 709 may be executed by a respective baseband unit.

At stage 700A, the central MAC layer 705 may classify the users into five subgroups UG1 through UG5. The subgroups UG1 and UG2 are users ready for migration to the new baseband unit. The subgroup UG3 comprises high mobility users. The subgroup UG4 comprises potentially impacted users. The subgroup UG5 comprises Idle users. Each subgroup of the subgroups UG1 through UG5 are assigned time-frequency resources at the physical layer of the old stack 707. This is indicated by the old stack 707, where ethe physical layer comprises time and frequency sets being numbered according to the corresponding subgroups e.g., the subgroups UG1 and UG2 are assigned to the same time and frequency resource set numbered “1-2”, the subgroup UG3 is assigned to the time and frequency resource set numbered “3” etc. The subgroup UG3 does not fulfill the migration criterion; however, the subgroups UG1, UG2, UG4 and UG5 fulfill the migration criterion.

At stage 700B, the subgroups UG1, UG2 and UG5 are migrated to the new baseband unit. This is indicated in FIG. 7B, where the physical layer of the new stack 709 is using now the time and frequency resource sets assigned for the subgroups UG1, UG2 and UG5 for processing the corresponding baseband signals.

At stage 700C, the subgroup UG4 is migrated to the new baseband unit. This is indicated in FIG. 7C, where the physical layer of the new stack 709 is using now the time and frequency resource set assigned for the subgroup UG4 for processing the corresponding baseband signals.

The subgroup of high mobility users UG3 is not migrated as it does not fulfill the migration criterion.

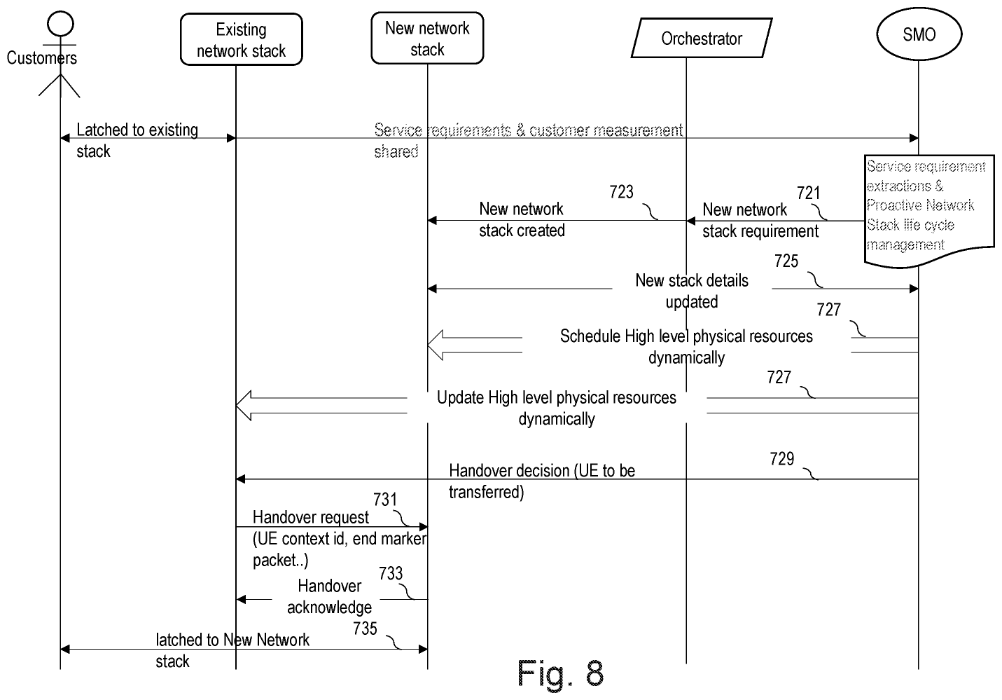

FIG. 8 is a signalling diagram of migration process between two deployed stacks in accordance with an example of the present subject matter.

The Service Management and Orchestration (SMO) unit may identify (721) the conditions in which a new network stack should be deployed and send instructions to the orchestrator. The instructions include the entire workflow that specifies how to reach the target state, e.g., which stack swap scenario to use and with which order and timings. The orchestrator may deploy (723) a new network stack or a part of it. Similarly, the procedure could have included deployment of new instances across multiple layers, e.g., the new virtualization layer and the network functions from the same or different vendor. SMO may update (725) details of the newly deployed network stack, e.g., configures it. Given the current network conditions and user activity in the existing network stack, SMO may prepare (727) the two stacks for the migration, in which it may dynamically schedule the physical resources in the newly deployed stack and updates the physical resources in the existing network stack. SMO may identify (729) the set of users that should migrate to the newly deployed stack and inform the existing network stack. This may not be necessarily the entire set of the users that must be migrated. Instead, the migration process may take several incremental rounds depending on the current user behaviour and network conditions. Hence, this step 729 and the steps that follow may repeat several times. As per the instruction from the SMO, the existing network stack may initiate (731) the migration procedure towards the newly deployed network stack, e.g., it may passe the user equipment (UE) context ID, end marker packet and similar. The newly deployed network stack may acknowledge (733) the migration. The users may be attached (735) to the new network stack.

Clause 1. A method for processing baseband signals for serving a group of users in a wireless communication system; the method comprising: providing a set of baseband units each being implemented in a respective hardware and software configuration, wherein the group of users are being served by a current baseband unit of the set of baseband units; selecting a specific baseband unit of the set of baseband units which is different from the current baseband unit; identifying users of the group of users that fulfil a migration criterion for migration to the selected baseband unit; ranking the identified users according to services accorded by the wireless communication system to the identified users; controlling the selected baseband unit to serve, instead of the current baseband unit, the identified users following their order.

Clause 2. The method of clause 1, wherein the selection of the specific baseband unit is performed in response to: receiving a request to migrate the group of users from the current baseband unit; or detecting that the current baseband unit does not fulfil a performance requirement for serving the group of users.

Clause 3. The method of clause 2, wherein the selected baseband unit is adapted to fulfil the performance requirement.

Clause 4. The method of clause 2 or 3, the performance requirement requiring specific values of and/or behaviour of network parameters and/or user parameters, wherein the network parameters comprise network behaviour indicators, the user parameters comprise user experience parameters and service utilization parameters.

Clause 5. The method of any of the preceding clauses 1 to 4, wherein the service accorded to the user comprises at least one of: a maximum transmission latency for transmission to or from a user and the system; a user class of the user; a maximum packet loss for packet transmission to or from a user; a minimum signal coverage quality.

Clause 6. The method of any of the preceding clauses 1 to 5, wherein the ranking comprises: grouping the identified users into two subgroups, the first subgroup comprising users whose accorded service is not impacted by an interruption time during a migration to the selected baseband unit, and a second subgroup comprising users whose accorded service is impacted by the interruption time; ranking the first subgroup users before the second subgroup users.

Clause 7. The method of clause 6, further comprising selecting users of the second subgroup whose perceived service is not impacted by the interruption time; and including the selected users in the first subgroup.

Cluse 8. The method of clause 6 or 7, further comprising: predicting user experience of the second subgroup of users; determining a level of impact of the accorded service using the user experience; and ranking the second subgroup of users according to the level of impact.

Clause 9. The method of clause 8, the user experience comprising at least one of: a mobility pattern, a service activity pattern or connection status pattern.

Clause 10. The method of any of the preceding clauses 6 to 9, wherein the first subgroup of users comprises Idle users.

Clause 11. The method of any of the preceding clauses 6 to 10, further comprising: after migrating the first subgroup of users, delaying the migration of the second subgroup of users for a defined delay period.

Clause 12. The method of any of the preceding clauses 1 to 11, wherein the migration criterion requires a maximum mobility of the user, wherein the mobility includes a speed or acceleration of the user, wherein the non-identified users of the group of users have a mobility higher than a threshold.

Clause 13. The method of any of the preceding clauses 1 to 12, wherein the ranking is performed using user profiles of the group of users.

Clause 14. The method of any of the preceding clauses 1 to 13, wherein the control of the selected baseband unit is performed by a central media access control (MAC) layer of the wireless communication system.

Clause 15. The method of any of the preceding clauses 1 to 14, wherein the control of the selected baseband unit comprises reassigning time and frequency resources between the current baseband unit and the selected baseband unit.

Clause 16. The method of any of the preceding clauses 1 to 15, wherein the method is performed automatically.

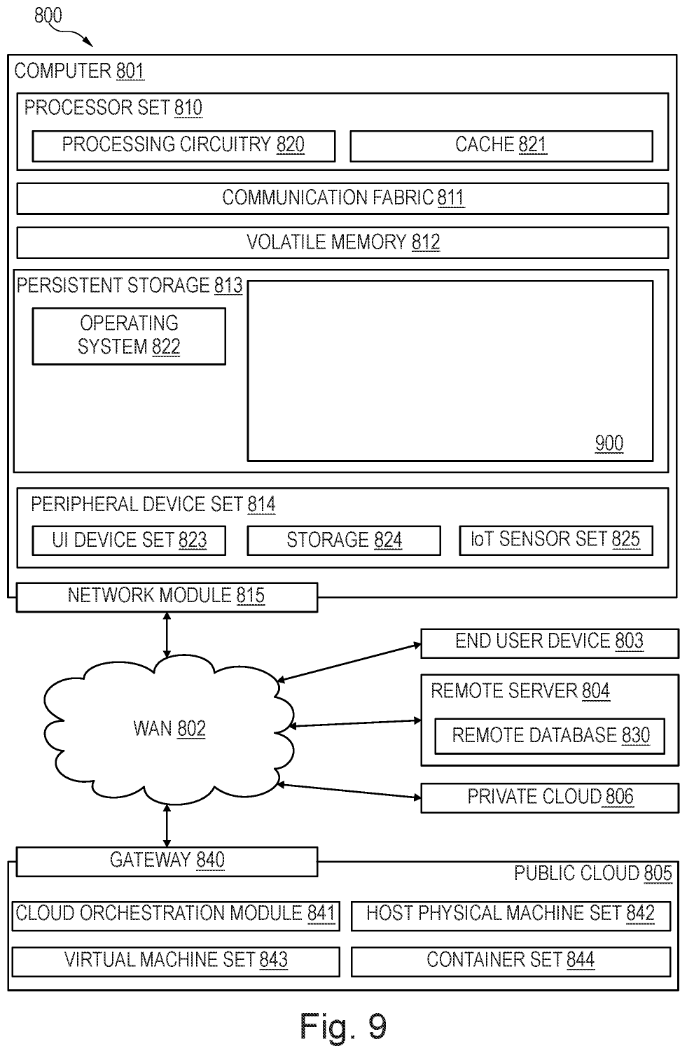

FIG. 9 is a computing environment in accordance with an example of the present subject matter Computing environment 800 contains an example of an environment for the execution of at least some of the computer code involved in performing the inventive methods, such as a baseband units deployment code 900. In addition to block 900, computing environment 800 includes, for example, computer 801, wide area network (WAN) 802, end user device (EUD) 803, remote server 804, public cloud 805, and private cloud 806. In this embodiment, computer 801 includes processor set 810 (including processing circuitry 820 and cache 821), communication fabric 811, volatile memory 812, persistent storage 813 (including operating system 822 and block 900, as identified above), peripheral device set 814 (including user interface (UI) device set 823, storage 824, and Internet of Things (IoT) sensor set 825), and network module 815. Remote server 804 includes remote database 830. Public cloud 805 includes gateway 840, cloud orchestration module 841, host physical machine set 842, virtual machine set 843, and container set 844.

COMPUTER 801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 830. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically computer 801, to keep the presentation as simple as possible. Computer 801 may be located in a cloud, even though it is not shown in a cloud in FIG. 9. On the other hand, computer 801 is not required to be in a cloud except to any extent as may be affirmatively indicated.

PROCESSOR SET 810 includes one, or more, computer processors of any type now known or to be developed in the future. Processing circuitry 820 may be distributed over multiple packages, for example, multiple, coordinated integrated circuit chips. Processing circuitry 820 may implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set may be located “off chip.” In some computing environments, processor set 810 may be designed for working with qubits and performing quantum computing.

Computer readable program instructions are typically loaded onto computer 801 to cause a series of operational steps to be performed by processor set 810 of computer 801 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 821 and the other storage media discussed below. The program instructions, and associated data, are accessed by processor set 810 to control and direct performance of the inventive methods. In computing environment 800, at least some of the instructions for performing the inventive methods may be stored in block 900 in persistent storage 813.

COMMUNICATION FABRIC 811 is the signal conduction path that allows the various components of computer 801 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 812 is any type of volatile memory now known or to be developed in the future. Examples include dynamic type random access memory (RAM) or static type RAM. Typically, volatile memory 812 is characterized by random access, but this is not required unless affirmatively indicated. In computer 801, the volatile memory 812 is located in a single package and is internal to computer 801, but, alternatively or additionally, the volatile memory may be distributed over multiple packages and/or located externally with respect to computer 801.

PERSISTENT STORAGE 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 may be a read only memory (ROM), but typically at least a portion of the persistent storage allows writing of data, deletion of data and re-writing of data. Some familiar forms of persistent storage include magnetic disks and solid state storage devices. Operating system 822 may take several forms, such as various known proprietary operating systems or open source Portable Operating System Interface-type operating systems that employ a kernel. The code included in block 900 typically includes at least some of the computer code involved in performing the inventive methods.

PERIPHERAL DEVICE SET 814 includes the set of peripheral devices of computer 801. Data communication connections between the peripheral devices and the other components of computer 801 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 823 may include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 may be persistent and/or volatile. In some embodiments, storage 824 may take the form of a quantum computing storage device for storing data in the form of qubits. In embodiments where computer 801 is required to have a large amount of storage (for example, where computer 801 locally stores and manages a large database) then this storage may be provided by peripheral storage devices designed for storing very large amounts of data, such as a storage area network (SAN) that is shared by multiple, geographically distributed computers. IoT sensor set 825 is made up of sensors that can be used in Internet of Things applications. For example, one sensor may be a thermometer and another sensor may be a motion detector.

NETWORK MODULE 815 is the collection of computer software, hardware, and firmware that allows computer 801 to communicate with other computers through WAN 802. Network module 815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (for example, embodiments that utilize software-defined networking (SDN)), the control functions and the forwarding functions of network module 815 are performed on physically separate devices, such that the control functions manage several different network hardware devices. Computer readable program instructions for performing the inventive methods can typically be downloaded to computer 801 from an external computer or external storage device through a network adapter card or network interface included in network module 815.

WAN 802 is any wide area network (for example, the internet) capable of communicating computer data over non-local distances by any technology for communicating computer data, now known or to be developed in the future. In some embodiments, the WAN 802 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 803 is any computer system that is used and controlled by an end user (for example, a customer of an enterprise that operates computer 801), and may take any of the forms discussed above in connection with computer 801. EUD 803 typically receives helpful and useful data from the operations of computer 801. For example, in a hypothetical case where computer 801 is designed to provide a recommendation to an end user, this recommendation would typically be communicated from network module 815 of computer 801 through WAN 802 to EUD 803. In this way, EUD 803 can display, or otherwise present, the recommendation to an end user. In some embodiments, EUD 803 may be a client device, such as thin client, heavy client, mainframe computer, desktop computer and so on.

REMOTE SERVER 804 is any computer system that serves at least some data and/or functionality to computer 801. Remote server 804 may be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data may be provided to computer 801 from remote database 830 of remote server 804.

PUBLIC CLOUD 805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844. It is understood that these VCEs may be stored as images and may be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware, and firmware that allows public cloud 805 to communicate through WAN 802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 806 is similar to public cloud 805, except that the computing resources are only available for use by a single enterprise. While private cloud 806 is depicted as being in communication with WAN 802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 805 and private cloud 806 are both part of a larger hybrid cloud.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

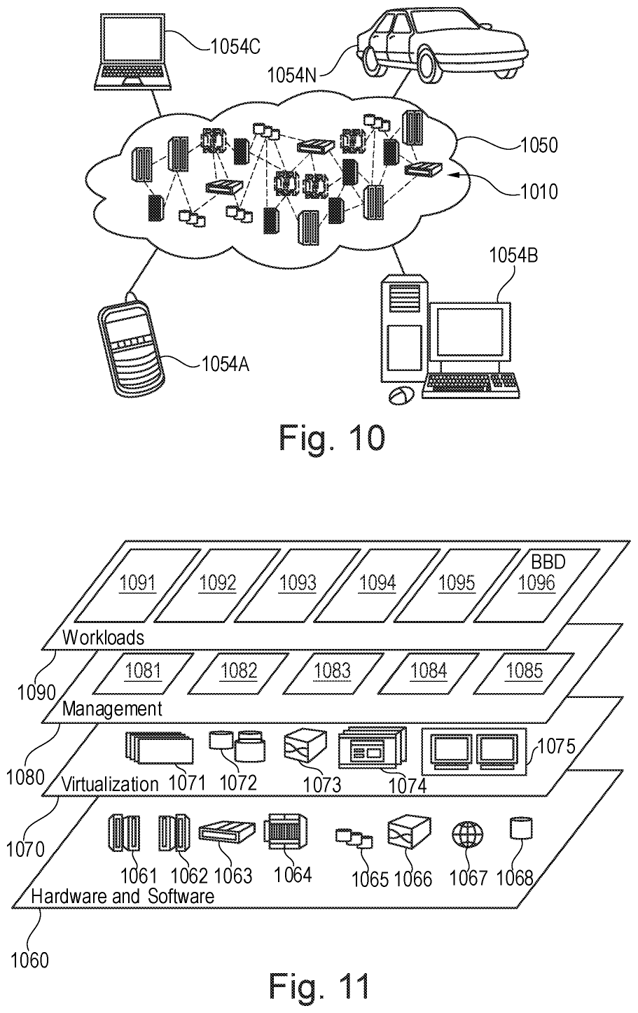

Referring now to FIG. 10, illustrative cloud computing environment 1050 is depicted. As shown, cloud computing environment 1050 includes one or more cloud computing nodes 1010 with which local computing devices used by cloud consumers, such as, for example, personal digital assistant (PDA) or cellular telephone 1054A, desktop computer 1054B, laptop computer 1054C, and/or automobile computer system 54N may communicate. Nodes 1010 may communicate with one another. They may be grouped (not shown) physically or virtually, in one or more networks, such as Private, Community, Public, or Hybrid clouds as described hereinabove, or a combination thereof. This allows cloud computing environment 1050 to offer infrastructure, platforms and/or software as services for which a cloud consumer does not need to maintain resources on a local computing device. It is understood that the types of computing devices 1054A-N shown in FIG. 10 are intended to be illustrative only and that computing nodes 1010 and cloud computing environment 1050 can communicate with any type of computerized device over any type of network and/or network addressable connection (e.g., using a web browser).

Referring now to FIG. 11, a set of functional abstraction layers provided by cloud computing environment 1050 (FIG. 10) is shown. It should be understood in advance that the components, layers, and functions shown in FIG. 11 are intended to be illustrative only and embodiments of the invention are not limited thereto. As depicted, the following layers and corresponding functions are provided:

Hardware and software layer 1060 includes hardware and software components. Examples of hardware components include: mainframes 1061; RISC (Reduced Instruction Set Computer) architecture based servers 1062; servers 1063; blade servers 1064; storage devices 1065; and networks and networking components 1066. In some embodiments, software components include network application server software 1067 and database software 1068.

Virtualization layer 1070 provides an abstraction layer from which the following examples of virtual entities may be provided: virtual servers 1071; virtual storage 1072; virtual networks 1073, including virtual private networks; virtual applications and operating systems 1074; and virtual clients 1075.

In one example, management layer 1080 may provide the functions described below. Resource provisioning 1081 provides dynamic procurement of computing resources and other resources that are utilized to perform tasks within the cloud computing environment. Metering and Pricing 1082 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 1083 provides access to the cloud computing environment for consumers and system administrators. Service level management 1084 provides cloud computing resource allocation and management such that required service levels are met. Service Level Agreement (SLA) planning and fulfillment 1085 provide pre-arrangement for, and procurement of, cloud computing resources for which a future requirement is anticipated in accordance with an SLA.

Workloads layer 1090 provides examples of functionality for which the cloud computing environment may be utilized. Examples of workloads and functions which may be provided from this layer include: mapping and navigation 1091; software development and lifecycle management 1092; virtual classroom education delivery 1093; data analytics processing 1094; transaction processing 1095; and a baseband deployment engine (BBD) 1096 in accordance with the present subject matter e.g., as described with reference to FIG. 2, 3, 4 or 5A.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

1. A method for processing baseband signals for serving a group of users in a wireless communication system; the method comprising:
providing a set of baseband units each being implemented in a respective hardware and software configuration, wherein the group of users are being served by a current baseband unit of the set of baseband units;
selecting a specific baseband unit of the set of baseband units which is different from the current baseband unit;
identifying users of the group of users that fulfil a migration criterion for migration to the selected baseband unit;
ranking the identified users according to services accorded by the wireless communication system to the identified users; and
controlling the selected baseband unit to serve, instead of the current baseband unit, the identified users following their order.

2. The method of claim 1, wherein the selection of the specific baseband unit is performed in response to receiving a request to migrate the group of users from the current baseband unit or detecting that the current baseband unit does not fulfil a performance requirement for serving the group of users.

3. The method of claim 2, wherein the selected baseband unit is adapted to fulfil the performance requirement.

4. The method of claims 2, the performance requirement requiring specific values of and/or behaviour of network parameters and/or user parameters, wherein the network parameters comprise network behaviour indicators, the user parameters comprise user experience parameters and service utilization parameters.

5. The method of claim 1, wherein a service accorded to a user comprises at least one of:
a maximum transmission latency for transmission to or from the user and the system; a user class of the user; a maximum packet loss for packet transmission to or from the user; or a minimum signal coverage quality.

6. The method of claim 1, wherein the ranking further comprises:
grouping the identified users into two subgroups, a first subgroup of the two subgroups comprising users whose accorded service is not impacted by an interruption time during a migration to the selected baseband unit, and a second subgroup of the two subgroups comprising users whose accorded service is impacted by the interruption time; and
ranking the first subgroup users before the second subgroup users.

7. The method of claim 6, further comprising:
selecting users of the second subgroup whose perceived service is not impacted by the interruption time; and
including the selected users of the second subgroup in the first subgroup.

8. The method of claim 6, further comprising:
predicting a user experience of the second subgroup of users;
determining a level of impact of the accorded service using the user experience; and
ranking the second subgroup of users according to the level of impact.

9. The method of claim 8, the user experience comprising at least one of a mobility pattern, a service activity pattern, or a connection status pattern.

10. The method of claim 6, wherein the first subgroup of users comprises idle users.

11. The method of claim 7, further comprising:
in response to migrating the first subgroup of users, delaying the migration of the second subgroup of users for a defined delay period.

12. The method of claim 1, wherein the migration criterion requires a maximum mobility of the user, wherein mobility includes a speed or acceleration of the user, and wherein non-identified users of the group of users have a mobility higher than a threshold.

13. The method of claim 1, wherein the ranking is performed using user profiles of the group of users.

14. The method of claim 1, wherein the controlling of the selected baseband unit is performed by a central media access control (MAC) layer of the wireless communication system.

15. The method of claim 1, wherein the controlling of the selected baseband unit comprises reassigning time and frequency resources between the current baseband unit and the selected baseband unit.

16. The method of claim 1, wherein the method is performed automatically.

17. A computer program product for processing baseband signals for serving a group of users in a wireless communication system, the computer program product comprising:
one or more computer-readable tangible storage medium and program instructions stored on at least one of the one or more tangible storage medium, the program instructions executable by a processor capable of performing a method, the method comprising:
providing a set of baseband units each being implemented in a respective hardware and software configuration, wherein the group of users are being served by a current baseband unit of the set of baseband units;
selecting a specific baseband unit of the set of baseband units which is different from the current baseband unit;
identifying users of the group of users that fulfil a migration criterion for migration to the selected baseband unit;
ranking the identified users according to services accorded by the wireless communication system to the identified users; and
controlling the selected baseband unit to serve, instead of the current baseband unit, the identified users following their order.

18. The computer program product of claim 17, wherein the program instructions executable by the processor capable of performing the method is provided as a service in a cloud environment.

19. A computer system for a wireless communication system, the computer system comprising:
a set of baseband units each being implemented in a respective hardware and software configuration, wherein a group of users are being served by a current baseband unit of the set of baseband units; the computer system comprising one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
selecting a specific baseband unit of the set of baseband units which is different from the current baseband unit;
identifying users of the group of users that fulfil a migration criterion for migration to the selected baseband unit;
ranking the identified users according to services accorded by the wireless communication system to the identified users; and
controlling the selected baseband unit to serve, instead of the current baseband unit, the identified users following their order.

20. The computer system of claim 19, wherein the computer system is a central media access control (MAC) layer of the wireless communication system, and wherein the set of baseband units are associated with one or more nodes of the wireless communication system.
